(19) United States
(12) Patent Application Publication
(10) Pub. No.: US 2023/0282856 A1
(43) Pub. Date: Sep. 7, 2023

(54) METHOD FOR OPERATING A FUEL CELL SYSTEM, AND FUEL CELL SYSTEM

(71) Applicant: Robert Bosch GmbH, Stuttgart (DE)

(72) Inventor: Patrick Dannenmann, Stuttgart (DE)

(21) Appl. No.: 18/020,020

(22) PCT Filed: Jun. 23, 2021
(86) PCT No.: PCT/EP2021/067153

§ 371 Date: Feb. 6, 2023

(30) Foreign Application Priority Data
Aug. 6, 2020 (DE) 10 2020 209 946.4

(51) Int. Cl. H01M 8/04858; H01M 8/04082

(52) U.S. Cl. CPC H01M 8/04947; H01M 8/04201

(57) ABSTRACT

The invention relates to a method for operating a fuel cell system (1) having a fuel cell stack (2) and a converter (3) in which method, during operation of the fuel cell system (1),
the fuel cell stack (2) is supplied with a medium via at least one component (4) located in a supply path of the fuel cell system (1),
the electrical energy is generated by means of the fuel cell stack (2) using the medium and is conducted to the converter (3), and
the output voltage of the fuel cell stack (2) is converted by means of the converter (3) into a voltage of a higher-level system (5) and is made available to the higher-level system (4).

According to the invention, during normal operation of the fuel cell system (1), the at least one component (4) for supplying the medium is directly supplied with electrical power via the fuel cell stack (2).

The invention further relates to a fuel cell system (1) which is suitable for carrying out the method according to the invention.

### BACKGROUND

The invention relates to a fuel cell system suitable for carrying out the method according to the invention or operable according to the method according to the invention.

A fuel cell system typically comprises a fuel cell stack for generating electrical energy, as well as a converter for adjusting the output voltage of the fuel cell stack to the voltage of a superordinate system. The superordinate system also typically supplies electrical power to components of the fuel cell system that serve to supply media to the fuel cell stack. The media are in particular a fuel, for example hydrogen, as well as oxygen. The fuel is supplied to the fuel cell stack via an anode path. As an oxygen provider, ambient air is typically supplied to the fuel cell stack via a cathode path. Both the anode and cathode paths have a plurality of components that require electrical power as the propulsion and/or actuation energy.

If at least a portion of the power that the converter transmits to the superordinate system is consumed immediately by the media supply components, it is no longer available as a usable power to the superordinate system. This not only means that at least a part of the power transmitted by the converter is no longer usable for the superordinate system, but also that a part of the converter resources are also required for converting non-usable power for the superordinate system.

The present invention attempts to remedy this problem. In particular, the loss-heavy power transmission via the converter is to be minimized in order to thus increase the efficiency of the overall system.

### SUMMARY

A method for operating a fuel cell system having a fuel cell stack and a converter is proposed, in which, during operation of the fuel cell system,
the fuel cell stack is supplied with a medium via at least one component located in a supply path of the fuel cell system,
the electrical energy is generated by means of the fuel cell stack using the medium and is conducted to the converter, and
the output voltage of the fuel cell stack is converted by means of the converter into a voltage of a higher-level system and is made available to the higher-level system.

According to the invention, during normal operation of the fuel cell system, the at least one component for supplying the medium is directly supplied with electrical power via the fuel cell stack.

By contrast to the prior art, the at least one component for supplying media during normal operation of the fuel cell system is therefore supplied with electrical power, not via the superordinate system, but rather via the fuel cell stack. For example, the necessary power can be tapped directly on the fuel cell stack. That is to say, the power required does not have to first pass through the converter. Its resources are thus conserved. As a result, the system efficiency is thus increased. Furthermore, the converter can be smaller in size. This in turn saves space and costs.

The supply of power to the at least one component for media supply via the fuel cell stack requires the component to support the voltage level of the fuel cell stack.

In the further development of the invention, it is proposed that the converter is operated bidirectionally and, during startup, the at least one component for the media supply is supplied with electrical power via the converter. This is because during the startup event, that is to say, when starting the fuel cell system, no electrical energy can yet be provided via the fuel cell stack. However, this is required by the at least one component arranged in the supply path so that the system can start up in the first place. In the start event, the converter is therefore operated in the reverse direction and supplies the required electrical energy to the at least one component. A converter that is bidirectionally operable is therefore preferably used in order to perform the method according to the invention.

A control unit is advantageously used so as to control the bidirectional operation of the converter. This can be a control unit of the fuel cell system or an external control unit that is connected to the fuel cell system for this purpose. With the help of the control unit, the bidirectional operation of the converter can be coordinated with the operating state of the fuel cell system.

The fuel cell system proposed for solving the task mentioned above further comprises a fuel cell stack, a converter, and at least one component located in a supply path of the fuel cell system for supplying media to the fuel cell stack. According to the invention, the at least one component is connected to the fuel cell stack via a power line, such that the component is supplied with electrical power via the fuel cell stack.

Through the proposed circuitry of the at least one component, the fuel cell system is suitable for carrying out the method according to the invention described above or is operable according to this method. Thus, the same advantages are achieved with the aid of the fuel cell system. The power for the media supply of the fuel cell system can be directly taken from the fuel cell stack, that is, without a detour via the converter. This conserves the resources of the converter. At the same time, the efficiency of the overall system is increased. A smaller converter can also be used in the proposed fuel cell system, saving design space and cost.

In further development of the invention, it is proposed that the at least one component for supplying media via a power line is connected to the converter. The component can thus also be supplied with electrical power via the converter. This is beneficial for the startup event. This is because when the fuel cell system is started up, the fuel cell stack does not immediately produce electrical energy, so that the power required by the at least one component is lacking. Here, the converter then jumps in as a power supplier.

Advantageously, the converter is therefore bidirectionally operable. Accordingly, in the startup event, the converter does not supply the power to the higher-level system but rather in reverse to the at least one component for the media supply. In this case, the component can be connected to the fuel cell stack and the converter via a common power line. The power line can further be a branch of a power line connecting the fuel cell stack to the converter.

The direct supply of power to the at least one component for media supply via the fuel cell stack requires that the component support the voltage level of the fuel cell stack. At least one component for supplying media to the fuel cell system is therefore configured for the voltage level of the fuel cell stack.

Further, it is proposed that the fuel cell system comprises a control unit, or is connected or connectable to an external control unit. With the help of the control unit, the converter can in particular be controlled when it is bidirectionally operable. During startup of the fuel cell system, the converter can be controlled via the control unit such that the required power of the at least one component for media supply is provided via the converter. After the startup of the fuel cell system, that is, during normal operation of the fuel cell system, the converter is actuated again so as to transmit the electrical energy generated by the fuel cell stack to the superordinate system after adjustment of the voltage level. The power required by the at least one component to supply media is then directly taken from the fuel cell stack.

### BRIEF DESCRIPTION OF THE DRAWINGS

The invention will be explained in more detail in the following with reference to the accompanying drawings. The figures show:

FIG. 1 a schematic illustration of a fuel cell system according to the invention, and

FIG. 2 a schematic illustration of a conventional fuel cell system according to the invention.

### DETAILED DESCRIPTION

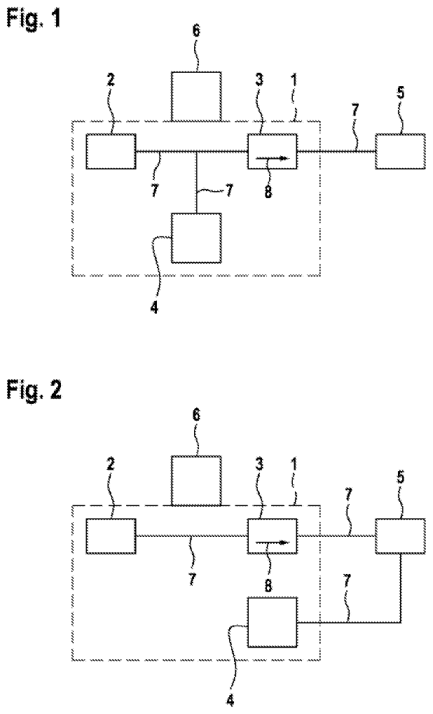

The fuel cell system 1 according to the invention shown in FIG. 1 can be used in a mobile or stationary manner. In the mobile application, the fuel cell system 1 can be used in order to provide electrical power to a drive component of a vehicle. A further possible application is the provision of power independent of a main drive for a secondary aggregate in a vehicle, for example a secondary aggregate for the climate control of a driver's cab, a passenger compartment, and/or a freight compartment. In the stationary application, the fuel cell system 1 can be used in order to briefly bridge unplanned failures of an electrical power supply.

In FIG. 1, the fuel cell system 1 shown supplies electrical power to a superordinate system 5. The electrical energy is generated using a fuel cell stack 2 of the fuel cell system 1.

Because the voltage position of the fuel cell stack 2 can deviate from that of the superordinate system, the fuel cell system 1 further comprises a converter 3 that adjusts the voltage of the electrical energy supplied by the fuel cell stack 2 to the voltage of the superordinate system 5. The converter 3 is connected to the fuel cell stack 2 via a first power line 7 and to the superordinate system 5 via a second power line 7. The converter 3 can also be configured so as to convert the current/voltage curve from DC to AC current, in addition to the voltage adjustment.

During operation of the fuel cell system 1, the fuel cell stack 2 requires various media, in particular a fuel as well as oxygen. To supply the media, the fuel cell system 1 comprises at least one component 4, which is connected to the first power line 7 via a further power line 7 and is thus connected to the fuel cell stack 2 on the one hand and to the converter 3 on the other hand. This has the advantage that, during normal operation of the fuel cell system 2, the power required by the component 4 can be taken directly from the fuel cell stack 2 without having to first pass through the converter 3. The converter 3 is thus protected and the converter 3 can be designed smaller, respectively.

Because at the startup of the fuel cell system 1, the fuel cell stack 2 cannot yet provide any electrical power but rather must be supplied with the necessary media, the at least one component 4 is supplied with the required power not via the fuel cell stack 2 but rather via the converter 3. The converter 3 is configured as a bidirectionally operable converter 3 (see arrow 8). The mode of operation is controlled using a control unit 6, wherein it can be a control unit 6 of the fuel cell system 1 or an external control unit 6.

To illustrate the advantages of the fuel cell system 1 according to the invention shown in FIG. 1, a conventional system is described below with reference to FIG. 2. Like parts are marked with like reference numbers.

The conventional fuel cell system 1 comprises a fuel cell stack 2 for power generation. This is conducted via a power line 7 to a converter 3. The latter adjusts the voltage level to the voltage of a superordinate system 5 and provides it thereto via a further power line 7. The fuel cell system 1 is further connected to a control unit 6. At least one component 4 in a supply path (not shown) of the fuel cell system 1 is provided for the media supply of the fuel cell stack 2. The electrical energy required by the component 4 is provided by the superordinate system 5 via a further power line 7. That is to say, the electrical energy has previously passed through the converter 3. A part of the power transferred from the converter 3 to the superordinate system 5 is thus not usable for the superordinate system 5. The resources of the converter 3 are also consumed in order to convert power that is not useful for the superordinate system 5. The conventional fuel cell system 1 comes with a converter 3, which is monodirectionally operable (see arrow 8). However, the converter 3 must be designed larger, such that the requirements for design space and costs increase.

1. A method for operating a fuel cell system (1) having a fuel cell stack (2) and a converter (3) in which, during operation of the fuel cell system (1),
the fuel cell stack (2) is supplied with a medium via at least one component (4) located in a supply path of the fuel cell system (1),
the electrical energy is generated by means of the fuel cell stack (2) using the medium and is conducted to the converter (3), and
the output voltage of the fuel cell stack (2) is converted by means of the converter (3) into a voltage of a higher-level system (5) and is made available to the higher-level system (4),
wherein, during normal operation of the fuel cell system (1), the at least one component (4) for supplying the medium is directly supplied with electrical power via the fuel cell stack (2).

2. The method according to claim 1,
wherein the converter (3) is operated bidirectionally and, during startup, the at least one component (4) for the media supply is supplied with electrical power via the converter (3).

3. The method according to claim 2,
wherein a control unit (6) is used for controlling the bidirectional operation of the converter (2).

4. A fuel cell system (1) comprising a fuel cell stack (2), a converter (3), and at least one component (4) located in a supply path of the fuel cell system (1) for supplying media to the fuel cell stack (2),
wherein the at least one component (4) is connected to the fuel cell stack (2) via a power line (7), such that the component (4) is supplied with electrical power via the fuel cell stack (2).

5. The fuel cell system (1) according to claim 4,
wherein the at least one component (4) is connected to the converter (3) via a power line (7) so that the component (4) is supplied with electrical power via the converter (3).

6. The fuel cell system (1) according to claim 4,
wherein the converter (3) can be operated bidirectionally.

7. The fuel cell system (1) according to claim 4,
wherein the at least one component (4) supports the voltage level of the fuel cell stack (2).

8. The fuel cell system (1) according to claim 4,
wherein the fuel cell system (1) comprises a control unit (6) or is connected or connectable to an external control unit (6).
